(19) United States
(12) Patent Application Publication
(10) Pub. No.: US 2025/0292344 A1
(43) Pub. Date: Sep. 18, 2025

(54) INTELLIGENT COACH-MEMBER DETERMINATION SYSTEM

(71) Applicant: BetterUp, Inc., Austin, TX (US)

(72) Inventors: Bharath Godlabeelu Suresh, Pune (IN); Daniel F. Bernardes, Cambridge, MA (US); Jordan Hochenbaum, Long Island City, NY (US)

(73) Assignee: BetterUp, Inc., Austin, TX (US)

(21) Appl. No.: 19/076,598

(22) Filed: Mar. 11, 2025

Related U.S. Application Data
(60) Provisional application No. 63/564,308, filed on Mar. 12, 2024.

(51) Int. Cl. G06Q 50/20; G06F 40/205

(52) U.S. Cl. CPC G06Q 50/205; G06F 40/205

(57) ABSTRACT

A multi-stage refinement process that utilizes a filtering engine, various subsystems, and artificial intelligence/machine learning (AI/ML) processes is deployed to identify a unique set of candidate-coaches for presentation to a user-member. A coach application may be instantiated on a user computing device that interoperates with a remote intelligent determination system. The determination system receives user data from queries presented to the user and/or remote third-party systems during a retrieval process. Such received data is encoded and ultimately utilized to generate a vector index that is then fed into a filtering engine with a number of subsystems. The subsystems include any one or more of user-defined policies and criteria, NLP (natural language processing), and ML/AI subsystems, among other subsystems, during a candidate generation process. A ranking and ordering process is then utilized to further refine the results before presentation to the user.

### CROSS REFERENCE TO RELATED APPLICATIONS

Pursuant to 35 U.S.C. § 119 (e), this application is entitled to and claims the benefit of the filing date of U.S. Provisional App. No. 63/564,308 filed Mar. 12, 2024, entitled “INTELLIGENT COACH-MEMBER DETERMINATION SYSTEM”, the content of which is incorporated herein by reference in its entirety for all purposes.

### BACKGROUND

Whether coaching consultations are conducted in-person or virtually, identifying the correct coach (or in a medical and therapy setting for an initial consultation with a physician or therapist) for the patient can be a daunting, if not impossible, task. Frequently, people are forced to consult multiple coaches before finding the correct one-someone with a personality, mannerisms, and life experiences, among other attributes that fit a patient's preferences, that can facilitate a positive and open relationship.

Current systems for identifying suitable coaches may utilize simplistic and/or time-consuming matching mechanisms that don't consider enough information or heuristics.

### SUMMARY

A multi-stage refinement process that utilizes a filtering engine, various subsystems, and artificial intelligence/machine learning (AI/ML) processes is deployed to identify a unique set of candidate-coaches for presentation to a user-member. A coach application may be instantiated on a user computing device that interoperates with a remote intelligent determination system. The determination system receives user data from queries presented to the user and/or remote third-party services during a retrieval process. Such received data is encoded and ultimately utilized to generate a vector index that is then fed into a filtering engine with a number of subsystems. The subsystems include any one or more of user-defined policies and criteria, NLP (natural language processing), and ML/AI subsystems, among other subsystems, during a candidate generation process.

Top candidates or sets of candidates generated from the filtering engine and its various subsystems are then subjected to ranking and ordering processes/stages independent of the filtering engine. Each stage within the process is compartmentalized into its own set of processing techniques to continuously refine the results to identify the best possible and optimized set of candidates for the member-user. The ranking stage may utilize some primary objective, such as a pointwise output. The ordering stage leverages various environments, including a hard-coded environment and AI/ML environment, that further refine the results from the filter and ranking stages. The hard-coded and AI/ML environments may interoperate to refine the results further. The AI/ML environment is distinct from the AI/ML subsystem in the filtering stage to hone in on the specifics for the ordering presentation of coaches to the user. The results of the ordering stage are finalized into a recommendation output of a set of coaches (e.g., four coaches) presented to the user-member.

Such a refinement process provides a systematic, optimized, and coherent process when identifying and proposing a unique set of coaches to a unique user. The intelligent determination system is optimized based on this design by compartmentalizing these various steps, making improving and optimizing individual sections of the process easier than more simplistic models that utilize some basic formula to select coaches. The system configuration also saves an individual module's resources by compartmentalizing individual stages, such as memory resources, since one stage's performance and processing do not affect another stage.

The intelligent determination system employs a containerized approach for its system's distinct components/modules. For example, the recommendation system, vector index, and user database (housing the coach and member data) are independently isolated into distinct containers. This setup provides isolation and modularization among the various components, enabling independent services/software per module. Independent containers can be tailored based on their specific functionality, thereby enhancing and optimizing that specific system. This modularization/isolation enables the setup of the recommendation system with a different technical stack than the backend coach application system, the coach application, and the vector index. In short, the determination system is configured as an optimized recommendation system that utilizes a streamlined refinement process and compartmentalized systems that save system resources (e.g., memory and processing).

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture, such as one or more computer-readable storage media. These and various other features will be apparent from reading the following Detailed Description and reviewing the associated drawings.

### DESCRIPTION OF THE DRAWINGS

FIG. 1 shows an illustrative environment of an intelligent determination system receiving information to make a coach recommendation to a user computing device;

FIG. 2 shows an illustrative layered architecture of the user device that may operate a coach application with extensibility to the intelligent determination system;

FIG. 3 shows an illustrative UI (user interface) of the user device with the coach application;

FIG. 4 shows an illustrative UI querying a user for information with an open-ended question;

FIG. 5 shows an illustrative UI querying the user for information with a selection of answers;

FIG. 6 shows an illustrative schema of example user information that the intelligent determination system may collect;

FIG. 7 shows an illustrative high-level backend architecture of the intelligent coach-member determination system;

FIG. 8 shows an illustrative diagram for creating a vector index with coaches and members;

FIG. 9 shows an illustrative environment in which the vectorized data is fed into a filter engine for candidate generation;

FIG. 10 shows an illustrative environment in which the ranked candidates, or coaches, are ordered and further optimized for a final presentation to an end user-member;

FIG. 11 shows an illustrative refining process utilized by the intelligent determination system;

FIG. 12 shows an illustrative UI of presented coaches on the user device;

FIG. 13 shows an illustrative end-to-end streamlined technical architecture of the intelligent determination system;

FIG. 14 shows an illustrative containerized architecture that facilitates isolation and modularity among the various components;

FIG. 15 shows a simplified block diagram of a computing device that may be used to implement the present intelligent coach-member determination system; and

FIG. 16 shows a simplified block diagram of a computing device, such as a server, that may be used to implement the present intelligent coach-member determination systems.

Like reference numerals indicate like elements in the drawings. Elements are not drawn to scale unless otherwise indicated.

### DETAILED DESCRIPTION

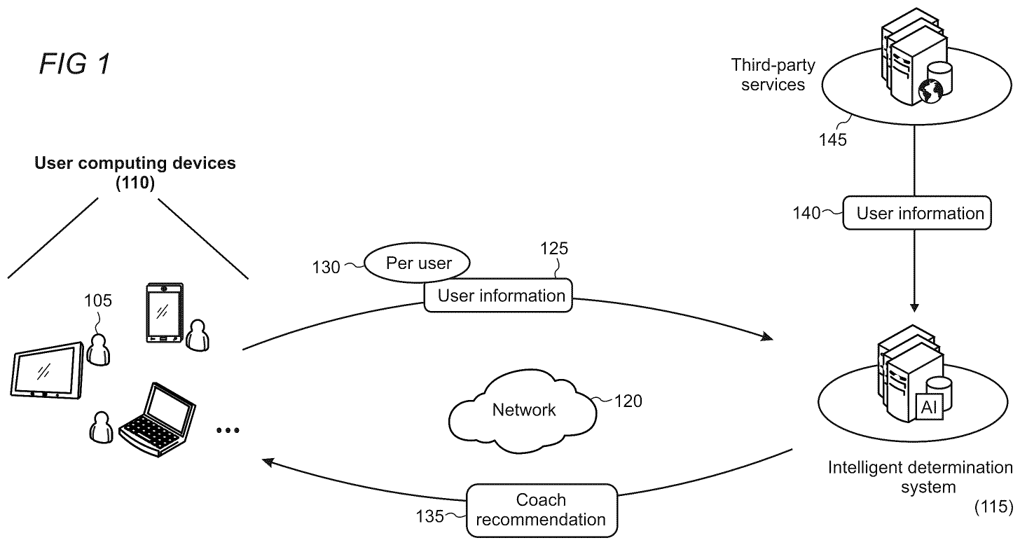

FIG. 1 shows an illustrative high-level environment in which users 105 operating user computing devices (alternatively referred to as “user devices”) 110 can transmit user information 125 to a remote intelligent determination system (alternatively referred to as “determination system”) 115. Users may be referred to herein as users, members, or coachees. The user information is transmitted on a per-user basis; each user may input information into respective user devices that transmit the input information to the determination system. The various computing devices may communicate and transmit information over a network 120, including any one or more of a local area network, wide area network, the Internet, and the World Wide Web.

Additionally, the intelligent determination system 115 may be configured to receive data, such as user information 140, from remote third-party services 145. Exemplary third-party services can be distinct services that users permit to receive data from, such as the user's employer, which may have basic identifying information for users, such as their name, address, position within the company, duration with the company, etc.

As discussed in greater detail below, responsive to receiving one or both of the user information 125, 140, the intelligent determination system 115 generates at least coach recommendations 135 that are transmitted over the network 120 to respective user devices 110. Each coach recommendation is unique to a user based on the unique user information 125, 140 provided, filtered, and refined by the determination system. Thus, each generated coach recommendation is per-user and transmitted personally, independently, and privately to individual users.

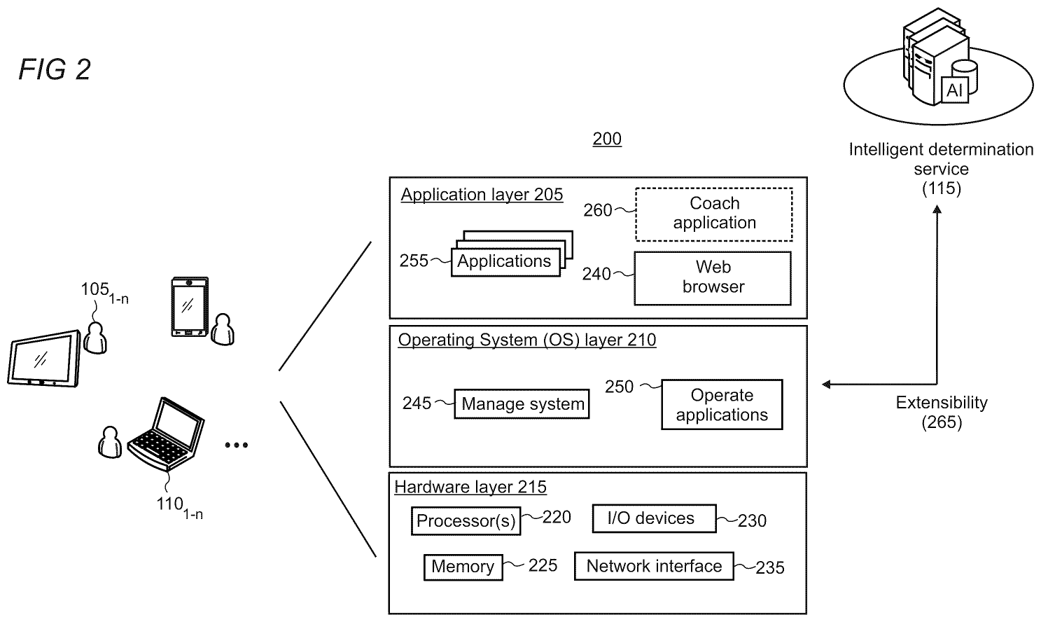

FIG. 2 shows an illustrative layered architecture 200 of exemplary user computing devices 110, which may be used to implement the intelligent coach-member determination system described herein. The architecture may apply to, for example, computing devices 110 operated by user-members 105, such as smartphones, tablet computers, laptop computers, desktop computers, and the like.

The computing devices 110 can include a hardware layer 215, operating system (OS) layer 210, and application layer 205. The hardware layer 215 provides an abstraction of the various hardware used by the computing device (e.g., input and output devices, networking and radio hardware, etc.) to the layers above it. In this illustrative example, the hardware layer supports processor(s) 220, memory 225, and input/output devices 230, including a microphone, speakers, camera (e.g., webcam), and pointing devices, among other peripheral devices. The computing device may likewise include a network interface 235, such as a network interface card (NIC) that enables wired (e.g., Ethernet) or wireless communications to a router or other computing device. For example, one or more network interface devices may enable the transmission of WiFi signals to a router and be configured with Bluetooth® or NFC (Near Field Communication) capabilities.

The application layer 205 in this illustrative example supports various applications 255 and a coach application 260. The coach application enables users 105 to input the user information 125 (FIG. 1) into a user device 110 and enables communications with the intelligent determination system 115. The web browser application 240 can access a remotely-instantiated coach application that interoperates with the determination system 115. The locally-instantiated coach application and browser have extensibility 265 to and interoperate with the remote determination system that hosts a backend coach application to facilitate the features described herein. Features implemented by the coach application discussed herein may be performed by the local computing device, the remote determination system, or a combination of both. Furthermore, any discussion regarding a locally-executing coach application 260 may alternatively reflect utilizing a plugin or the web browser application that accesses a uniform resource locator (URL) at which the remote coach application runs.

Although only certain applications are depicted in FIG. 2, any number of applications can be utilized by the user computing devices 110. The applications are often implemented using locally executing code. However, in some cases, these applications can rely on services and/or remote code execution provided by remote servers or other computing platforms, such as those supported by a service provider or other cloud-based resources.

The OS layer 210 supports, among other operations, managing system 245 and operating applications/programs 250. The OS layer may interoperate with the application and hardware layers in order to perform various functions and features.

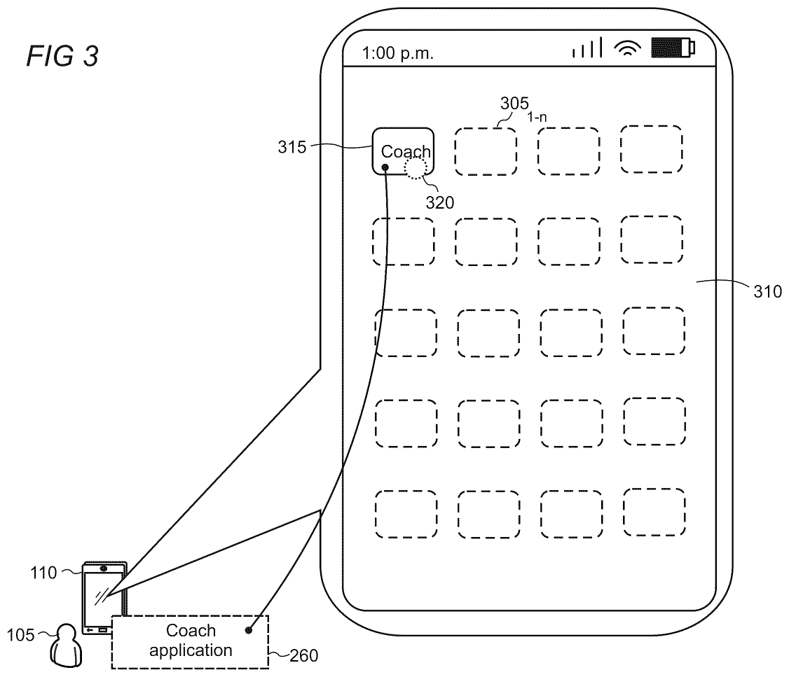

FIG. 3 shows an illustrative UI (user interface) 310 presented on a display of a user computing device 110 operated by user 105. The coach application 260 is instantiated on the user device. A home screen of the user device includes a series of icons 305, respectively associated with individual applications 255 (FIG. 2). Coach application icon 315 is associated with the coach application 260. The user selects 320 the coach application icon 315 when the user wishes to access/open the coach application 260. The user's input may be performed using a touchscreen display or other input methods, such as a pointing device, voice commands, keyboard, etc.

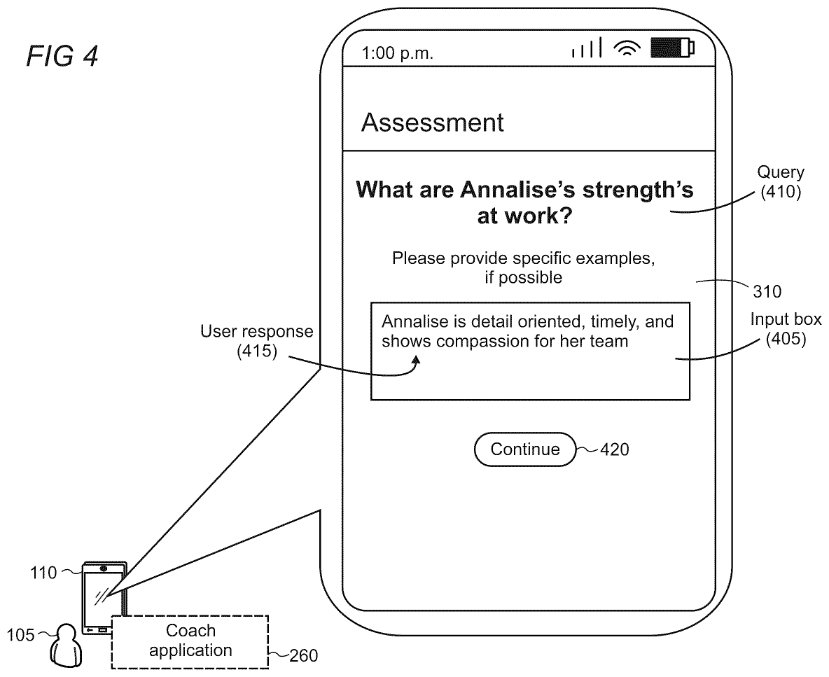

FIG. 4 shows an illustrative UI 310 on the user device 110 in which the coach application queries the user 105 for information about themselves. In this example, the query 410 asks the user what Annalise's strengths are at work. The coach application provides the user with an input text box 405, inside which the user can type their open-ended answer. The user's response is shown by reference numeral 415. In this regard, the coach application 260 or the intelligent determination system 115 may leverage natural language processing (NLP) to parse the user's answers and create meaning from them. NLP is an arm of artificial intelligence (AI) and machine learning (ML) processing that involves lexical (structure) analysis, parsing, semantic analysis, discourse integration, and pragmatic analysis. This data may be arranged in some useable format by the coach application 260 or determination system 115, such as in a spreadsheet or .csv format.

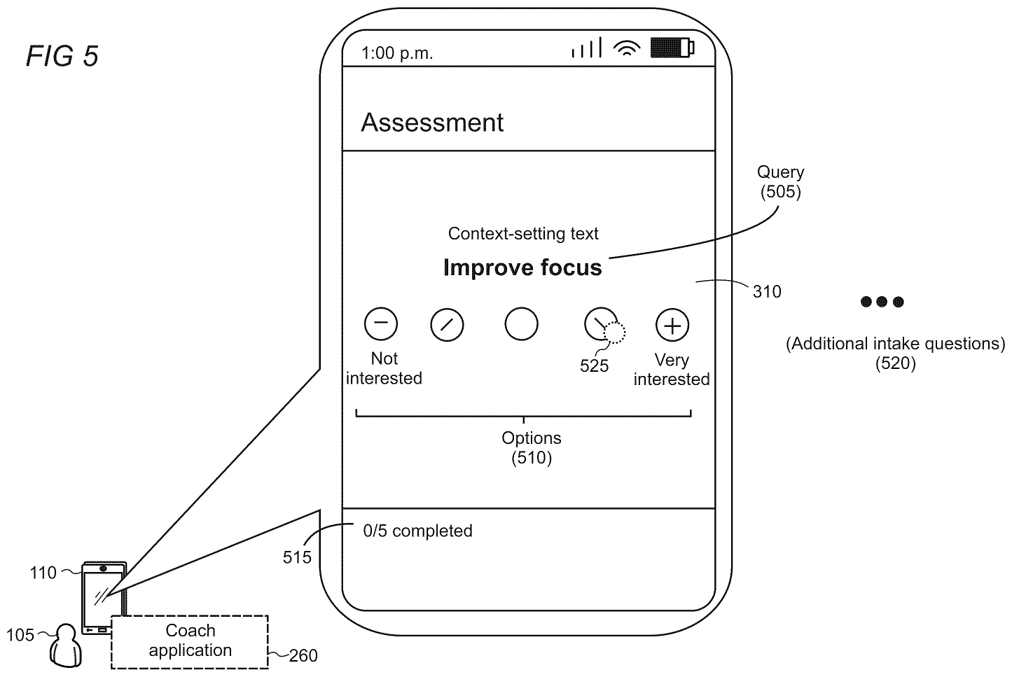

FIG. 5 shows an illustrative UI 310 in which the coach application 260 renders a different query 505 to the user 105. Here, the coach application provides the user with five options 510 of varying degrees by which the user can select their level of desire to “Improve focus.” The answers range from “Not interested” to “Very interested” and levels in between. This query may be the first of five questions, as representatively shown by reference numeral 515. While only five questions are shown here, any number of questions may be asked, such as 10, 20, etc. Once the user enters their input 525 on one of the options 510, the coach application proceeds to the remainder of the queries and presents additional intake questions 520. The questions are ultimately used to create a profile for that unique user, which can then be utilized to proprietarily select an ideal coach for the user-member.

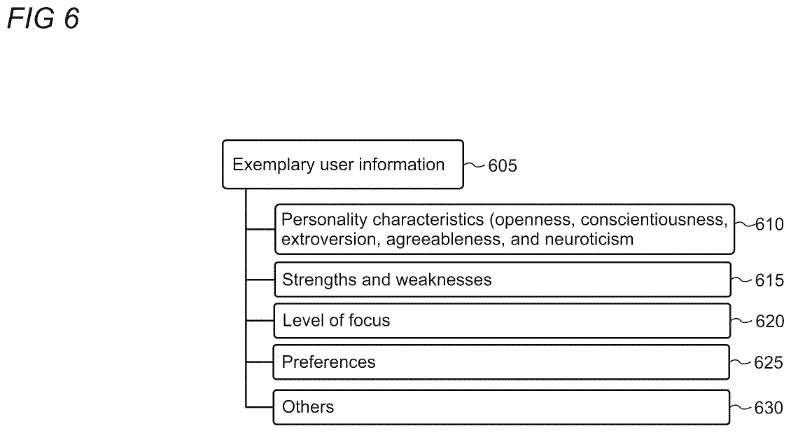

FIG. 6 shows an illustrative schema of example user information 605 that may be collected by the coach application 260 and intelligent determination system 115 via intake queries or third-party services 145. Exemplary and non-exhaustive collected user information can include personality characteristics (e.g., openness, conscientiousness, extroversion, agreeableness, and neuroticism) 610, strengths and weaknesses 615, level of focus 620, preferences 625, and other information 630.

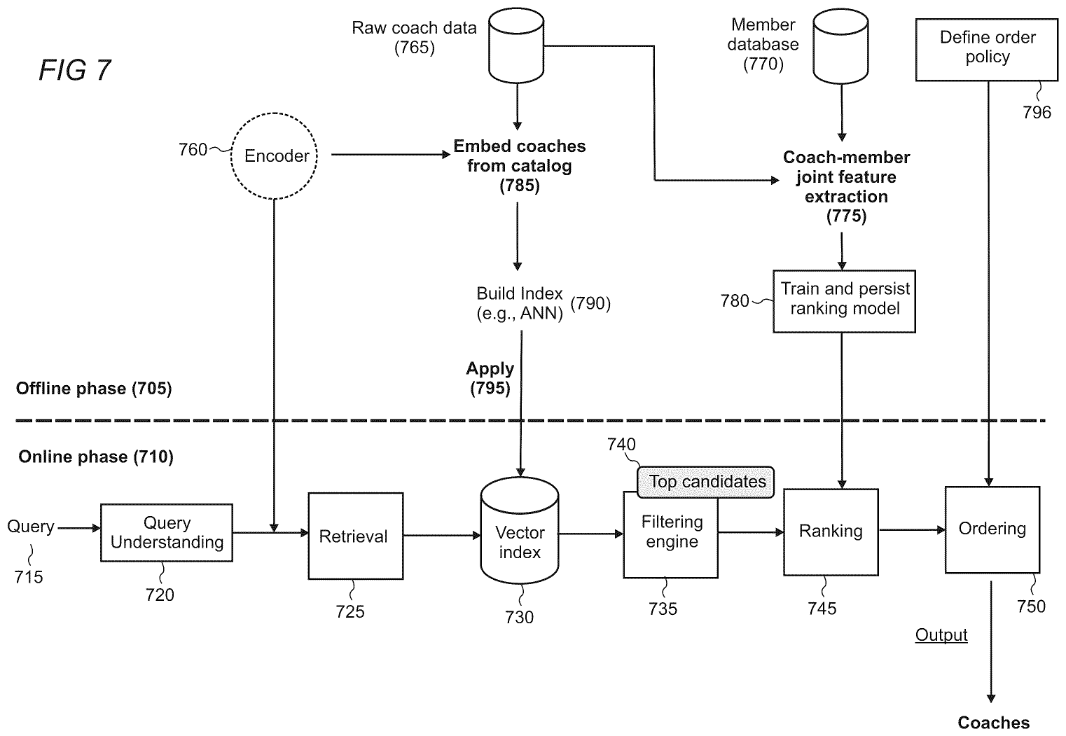

FIG. 7 shows an illustrative high-level backend architecture of the intelligent determination system 115. The setup can be separated into an online phase 710 and an offline phase 705. During the online phase, the users 105 are participants in the process by answering queries, and such information is processed and used to propose coaches 755 to the user. The offline phase is separate from the user's input and rather processes and uses information distinct from the user. For example, the offline phase may manage coach data, build coach indexes, train AI-ML models, and define order policies that are then input into the online phase processing for coach selection.

Referring to the online phase 710, the user 105 operating the coach application 260 is presented with queries 715 (FIGS. 4-6) received at the coach application and/or the intelligent determination system 115. Any discussion of receiving or processing data during the online or offline phases may be performed by one or both of the locally-instantiated coach application, the remote determination system 115, or a hybrid approach. For example, the user device 110 may transmit received answers to user queries to the remote determination system for processing, although in some scenarios, the coach application may receive information from the determination system to locally perform processing. Thus, characterizations of the diagram's steps may be referred to generally as the “system” to signify either the user device or the determination system. In step 720, the system develops an understanding of the user based on the received answers or data.

In step 725, the system enters a retrieval stage by which the system consumes user information, such as a member profile, preferences and other interest information collected from the preceding query steps. The collected information is a combination of categorical, numerical, and unstructured data encoded in a vector space at vector index 730. The vector space allows complex operations to be performed on the collected information. A human user cannot realistically process the large amount of collected information in its raw form. The vectors that are created allow operations, such as AI/machine learning to be integrated into the process of generating recommendations.

An encoder 760 is implemented at one or both of the offline phase 705 or online phase 710. In the online phase, the encoder 760 encodes the incoming member information and generates a vector representation for utilization at later stages so that consistent data can be processed. The encoder uses raw coach data 765 from a catalog or database in the offline phase. The system may use a fine-tuned autoencoder-style transformer model and may embed coach data from a catalog, as representatively shown by reference numeral 785. Using this encoded data, the system, such as the determination system 115, can build an index 790, such as an ANN (approximate nearest neighbor) index, although other indexes are also possible. The developed index is then applied 795 into the vector index 730 with the user retrieved user data. The vector index 730 is improved to combine both types of data.

In step 735, the data in the vector index is filtered to identify top candidates 740 to present to a user 105. The online phase processing is performed responsive to an individual user being onboarded onto the system. Thus, the query, retrieval, and subsequent stages are performed for a unique user that was onboarded. At the filtering stage, the system, such as the determination system 115, consumes the multiple candidate sets generated in the previous stage and filters them based on multiple types of user-defined filter policies to address various requirements of the multiple parties, members and coaches, that are involved within the platform. The system provides mechanisms to generate multiple candidate sets, if required, based on different embedding and filtering policy criteria.

In step 745, the generated top candidates 740 from the previous filtering stage are ranked using proprietary policies. At this stage, the system, such as the determination system 115, consumes the initial set of candidates after accounting for various filtering policies and then scores them against the seed query in a pointwise manner through a ranking model that is developed offline and trained periodically. The candidates are scored via a ranking model, trained usually with a pointwise ranking objective, but not limited to a single objective. The system optimizes for a high precision score with the ranking set. The smaller ranked set of candidates is further passed for the ordering stage, during which, based on heuristics (rule-based) and/or one or more learned ML models, the system reorders the recommendation set to meet other objectives required.

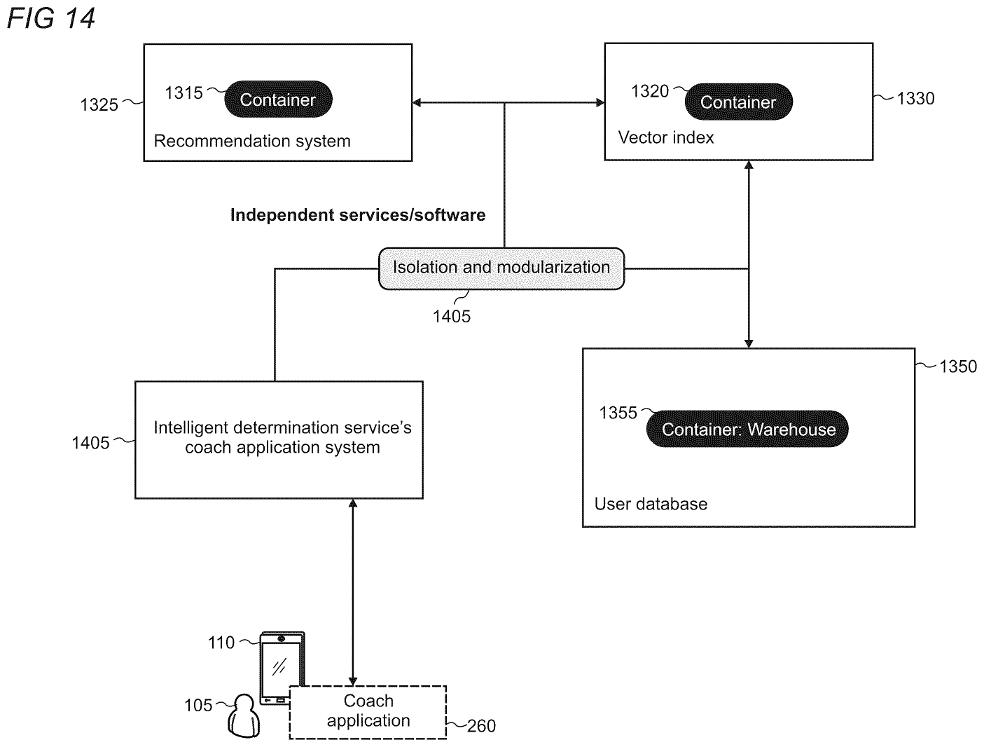

In step 750, the system orders the ranked candidates from the previous stage and then outputs the coaches 755 for presentation to the user 105 on user device 110. The system, such as the determination system 115, is configured to incorporate various ad-hoc requirements or other contextual priorities as required by the platform defined as order policies, which consumes the ordered set of candidates from the ranker and re-ranks them as per the ordering objective. One, both, or a mix of ML models or heuristics achieves this. In certain contexts, a novel re-ranking model can also be learned based on historical datasets to optimize multiple objectives and automatically pick appropriate solutions. Essentially, the detailed, customized, and proprietary stages utilized by the intelligent determination system 115 enables the continuing refinement of coach recommendations to unique users based on a variety of factors and AI-based improvements as time progresses and the system continues to learn and improve. Such a system creates not only a more accurate and optimized recommendation system but also provides a containerized system to improve system performance by making each system component independent of the other, as discussed in greater detail below with respect to FIG. 14.

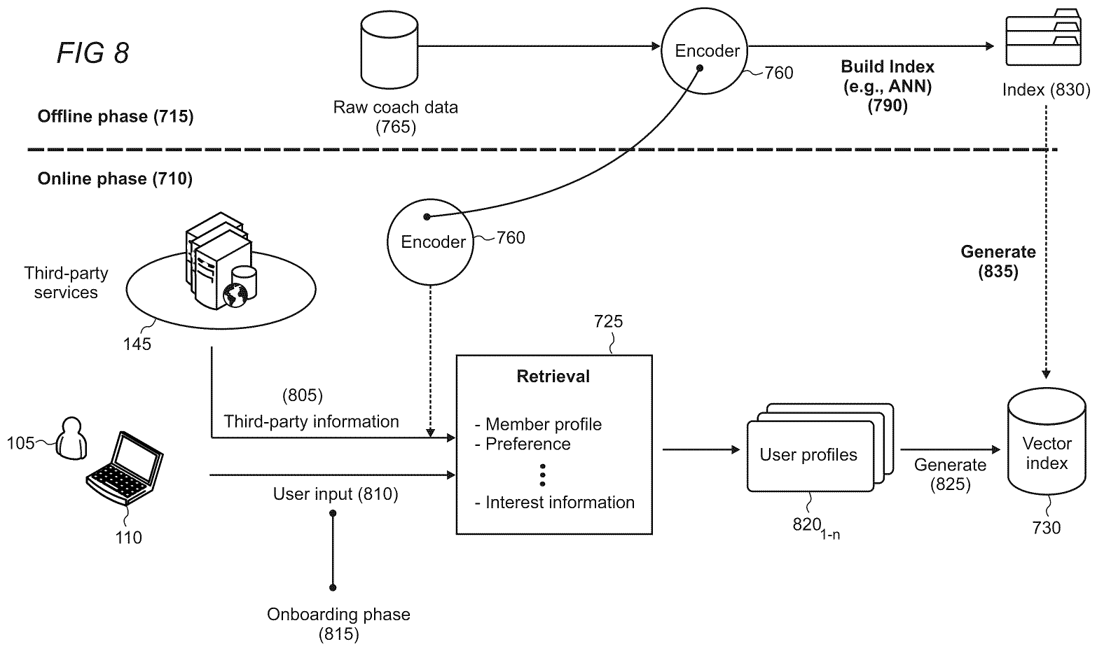

FIGS. 8-10 show illustrative diagrams and environments in which additional details into the processes of FIG. 7 are shown. Referring first to FIG. 8, the system retrieves information at the retrieval stage shown in step 725. The retrieved data can include user input information 810 or third-party information 805 from one or more third-party services 145. The user input information may be derived directly from the user 105 at their user device 110 during an onboarding phase 815 (FIGS. 4-5). The third-party information may come from a variety of sources, such as the user's employer, and can include the user name, birth date, address, position within the company, duration with the company, etc. The online phase 710 may leverage an encoder 760 that encodes the information into a usable vector index format. The encoder may be the same encoder used during the offline phase or may be a separate and independent module.

The retrieval stage 725 results in the development of individual user profiles 820 for coaches and members/coachees. That is, specific data such as member profiles, user preferences, and interest information, among other user information, are associated with unique users to generate profiles. This data is then processed into a vector index 730 that includes data for both members and coaches. The online phase of the user onboarding process generates 825 the vector index, and the offline phase takes the raw coach data 765 to build the index 830, as representatively shown by reference numeral 790. The determination system 115 takes this index 830 and generates 835 the vector index with the coachees. The coach and member data are put into the vector index 730 for subsequent filtering and refining when identifying suitable coaches.

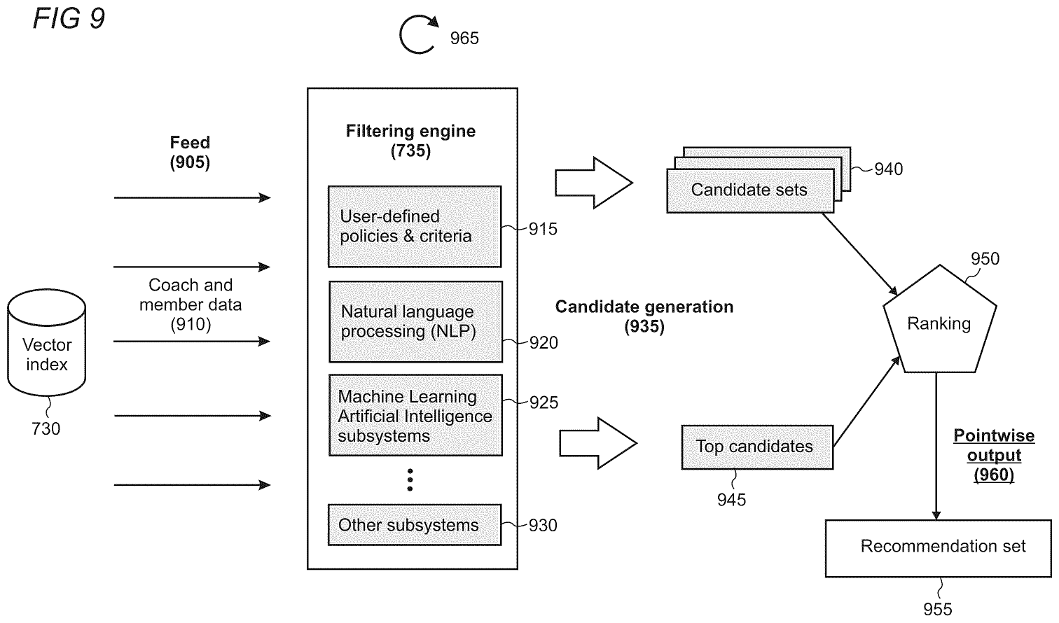

FIG. 9 shows an illustrative diagram in which the created vector index 730 is filtered and processed to begin the refinement process by which a selection of coaches is identified and presented to the user 105. A filtering engine 735 of the intelligent determination system 115 is fed the coach and member data 910 from the vector index. The filtering engine implements a number of subsystems for candidate generation 935 for unique users 105. For example, the filtering engine employs a user-defined policies and criteria subsystem 915, natural language processing (NLP) subsystem 920, machine learning and artificial intelligence subsystem 925, and other subsystems 930. Any one or more of the subsystems can be utilized during the filtering stage. The filtering may repeat 965 so that each desired subsystem can process the data. The subsystems may be placed in a certain order or randomly. For example, some subsystems may rely on subsequently processed data in some scenarios, but in other scenarios, each subsystem may refine the data independently and without consequence from another subsystem.

User-defined policies and criteria may include, for example, the user information described in FIGS. 4-6. Other user information can include preferences such as coach gender, weekly or daily availability, language, and user-centric information. This criteria may be compared to the coach information to ensure the recommended coaches match the user's criteria and policies.

The NLP subsystem 920 may parse user-input information, such as open-ended answers shown and described in FIG. 4. NLP is a branch of AI that analyzes, understands, and generates results that enable human language to interface with computer language. The NLP subsystem may first clean the input data (e.g., from input box 405), such as by removing special characters, symbols, punctuation, HTML tags, etc. Such information is typically noise in the data and difficult for the machine to process. The specific data cleaning techniques are specific to the NLP application used and desired results. The cleaned data may then enter a preprocessing stage that involves mining the data to transform the raw data into an understandable format. This can include mining for specific terms that are transformed into a single format. One example of such preprocessing is making similar words with uppercases or abbreviations into a single lower-case term.

The preprocessed data may be tokenized by breaking up the text into individual words called tokens. Such tokenization can be proprietary to the coach application 260 or determination system 115, or open-source libraries such as NLTK (natural language toolkit) can be used. Removal of stop words may be performed on the data, such as removing words like “the,” “is,”, “a,” etc., which provide low value and may add noise to the data. The data may enter a stemming process by which words are reduced into their stem/root word (e.g., “finishes,” “finishing,” “finished,” may each be transformed to “finish.”). Such processing can also include the lemmatization of words to ensure that reduced words are transformed into a meaningful term (e.g., “caring” is transformed to “care” instead of “car”). The processed words can then be subject to vectorization (e.g., Bag of Words (BoW), by which text is converted into numbers to numerically represent the text data and enables further processing.

Using the NLP subsystem, the received human responses from the user 105 or third-party service 145 can be understood to assess a proper coach for the user based on information about the user. In this regard, the NLP subsystem may be utilized first, and then the processed information can be utilized by, for example, the ML/AI subsystem or other subsystems that leverage the decoded user information in selecting appropriate candidate-coaches.

The ML/AI subsystem 925 can create, train, reference, and refine an AI model to process received coach and member data and identify the most appropriate recommendation for members. The ML/AI subsystem utilizes an algorithm to develop a predictive model based on the received data. The subsystem ingests the coach and member data 910 and subsequently may clean, prepare, and manipulate the data. For example, the data may be randomized to reduce the possibility of an order affecting the machine learning process and separated between a training set for training the model and a testing set for testing the trained model. Other forms of data manipulation may be performed as well, such as normalization, error correction, and the like.

The ML/AI subsystem 925 trains and tests the model. The model training may be used to incrementally improve the model's ability to make accurate recommendations. The model training may use the features contained in the data to form a matrix with weights and biases against the data. Random values within the data may be utilized to attempt the prediction of the output based on those values. This process may repeat until a more accurate model is developed, which can predict correct outputs. The model may subsequently be evaluated to determine if it meets some accuracy threshold (e.g., 70% or 80% accuracy), and then the predictive model will be deployed to make recommendations by the filtering engine 735. Over time the ML/AI subsystem can periodically be further trained and refined based on the availability of data.

Once the filtering engine 735 filters the coach and member data 910 using one or more of its subsystems and has optionally repeated 965 some filtering subsystem process, candidate generation 935 occurs based on the filtered results. The filtering engine may output candidate sets 940 or top candidates 945, which are then fed into a ranking 950 engine or phase. While various grading mechanisms may be used to intelligently assess and identify a best-suited coach for a member, one exemplary method is using a cosine metric, such as cosine similarity or cosine distance. Cosine similarity may relate to the similarity between the data, such as the filtered data.

The filtering engine may output a set of top candidates 945 or multiple candidate sets 940, depending on the implementation. Top candidates can include a set of three, four, 10, or any number of candidates that are top-rated based on the filtered ingested data. Candidate sets may include multiple sets of several candidates (e.g., four candidates per set) that have been identified and then are fed into the ranking 950 phase.

Filtering engine 735 may improve the performance of ranking engine 950 and the generation of recommendation set 955. The amount of data coach and member data 910 may be very large. To rank all of the candidates may be computationally expensive. However, removing some candidates may remove good candidates from the ranking process. Also, it may not be possible for a human to filter such a large dataset. Filtering engine 735 improves the filtering to select top candidates 945 or candidate sets 940. The ranking process may be performed faster using the filtered data compared to if the entire data set was used. Also, filter engine 735 may intelligently filter candidates such that top candidates remain in the ranking process while removing other candidates that may not be good matches. Further, the filtering process may be performed faster than analyzing all the entire dataset in the ranking process. By combining the filtering process and using the ranking process with the filtered dataset, recommendation set 955 can be generated faster than ranking the entire dataset.

In some implementations, the ranking phase may utilize a pointwise output 960 and propose a recommendation set 955 accordingly. For example, users with the highest number of points may be the final results provided to the user 105.

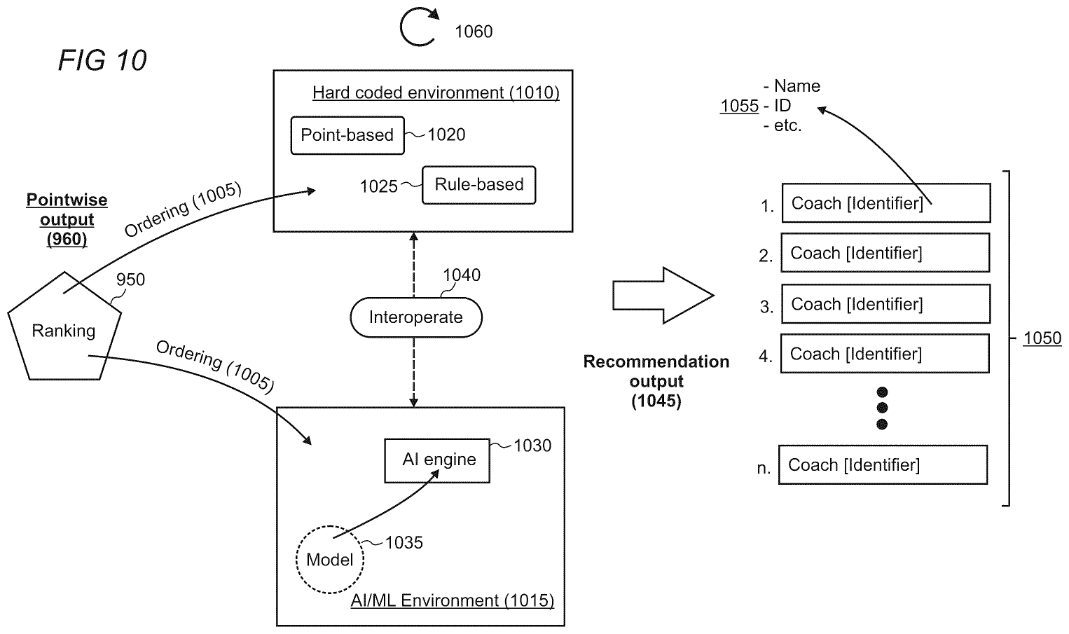

FIG. 10 shows an illustrative environment in which the pointwise output 960 from the ranking 950 engine/phase is then subjected to further refining in an ordering 1005 process. Either the entire recommendation set 955 is provided to the ordering process or the top candidates that satisfy some threshold (e.g., the top seven candidates, the first 75% of candidates, etc.). Example ordering processes can include a hard-coded environment 1010 or an AI/ML environment 1015. Each of these environments may interoperate 1040 with each other such that the ranked results can be subjected to each ordering environment to develop the most optimized results.

The hard-coded environment 1010 may leverage a point-based 1020 or rule-based 1025 heuristic ordering system. This ordering environment may help achieve objectives when providing a recommendation to the user-member 105. Example point-based methods can include verifying that each coach up for recommendation satisfies some pre-set threshold of similarity to the user-member. For example, utilizing a numerical score assigned to each user after each stage in the process (e.g., retrieval, filtering, ranking, and ordering), the ordering environment may verify that the coach's score is above some threshold before being provided to the user. In this regard, the system may decide to remove a coach even if that means reducing the total number of recommended coaches to the user if one or more coaches do not meet some minimum threshold score. The rule-based 1025 ordering process may include, for example, verifying that, despite an overall satisfying selection of a coach for a unique user, the coach does not have some flag that makes them a poor match for the member. For example, if the coach and member are in completely different time zones that are 16 hours apart (e.g., the time difference from parts of the USA and Australia), then the coach may not be an appropriate fit. In some scenarios, the result may be exclusionary.

The AI/ML environment 1015 is a further refining process for ordering the candidates that leverages an AI engine 1030 and model 1035. The description of artificial intelligence processing provided above with respect to the ML/AI subsystem 925 may apply to the AI engine here as well.

The AI engine 1030 at the ordering stage 1005 is employed for a distinct reason from the ML/AI subsystem 925 because the AI engine is tailored to identify, select, and order the candidates in the best possible fashion. Despite the overlap between the stages in which both stages wish to identify the most suitable candidate for a member, both stages are distinct and can be individually and independently optimized.

For example, leveraging an AI/ML environment 1015 enables the intelligent determination system 115 to recognize other objectives when ordering results for the user. Based on the trained model 1035, the determination system may have learned that ordering candidates based on certain criteria can result in optimized results that are more desirable to user-members 105. Although FIG. 10 shows that the hard-coded and AI/ML environments 1010, 1015 may interoperate 1040, in some scenarios, only a single environment may be used. The system may be configured first to have the pointwise output 960 go through the hard-coded environment first and then the AI/ML environment, or vice versa. Alternatively, the two environments may be completely independent of each other.

The intelligent determination system 115 provides a recommendation output 1045 from the ordering processes 1005, including a series of ordered coaches 1050. Each coach may have an identifier 1055, such as their name, ID (identification), etc. The number of coaches recommended may vary depending on the scenario. For example, the system may ideally wish to output seven recommendations to the user 105, but based on the various heuristics and ranking/ordering phases, the system may only wish to present four coaches to the user from the outset—that is, four identified high-quality coaches instead of seven that may include some less optimal results. In other scenarios, the system may be designed to provide a set number of coaches to the user regardless of the grading (e.g., the top five candidates).

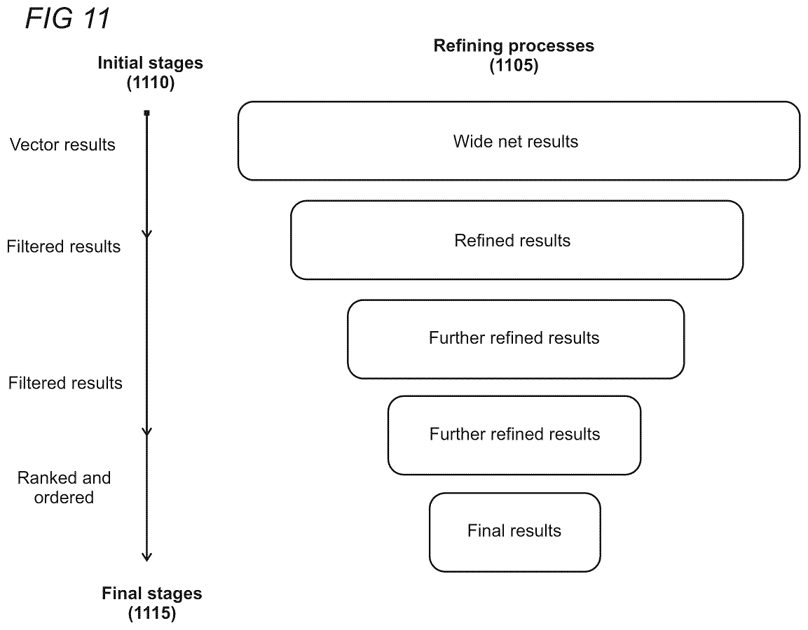

FIG. 11 shows an illustrative diagram in which the refining process 1105 of the intelligent coach-member determination system is emphasized and shown. The refining process begins at initial stages 1110 and then progresses—and the results refined—toward the final stages 1115. The initial stages may include the query and retrieval stages (FIGS. 7 and 8), and the final stages may include the ranking and ordering stages (FIGS. 9 and 10). As shown, intelligent determination system 115 casts wide net results at the earlier stages to capture a large pool of potential candidates for a member-user 105. The determination system 115 then continuously refines these results in one or more filtering stages using one or more subsystems and then ultimately ranks and orders the candidates to derive the final results.

Such a refinement process provides a systematic, optimized, and coherent process when identifying and proposing a unique set of coaches to a unique user 105. The intelligent determination system 115 is optimized based on this design by compartmentalizing these various steps, making improving and optimizing individual sections of the process easier than more simplistic models that utilize some basic formula to select coaches. The system configuration also saves an individual module's resources by compartmentalizing individual stages, such as memory resources, since one stage's performance and processing do not affect another.

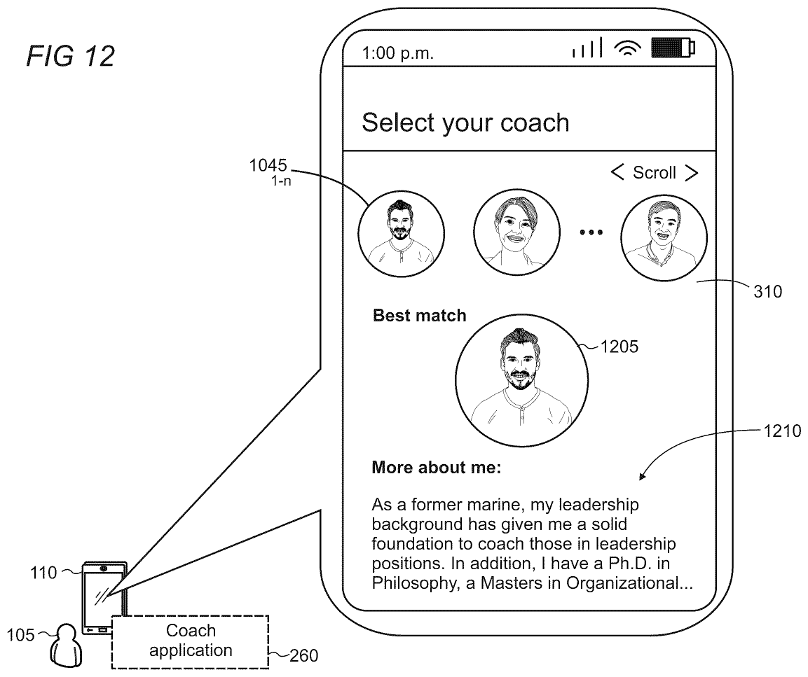

FIG. 12 shows an illustrative UI 310 in which the recommendation output 1045 of coaches 1050 (FIG. 10) is exposed to the user 105 on the user device 110. The UI prominently presents the best match 1205 to the user and a biography 1210 about the coach. The user can select among other presented coaches, such as by using the touchscreen display or other input mechanism, after which the coach application 260 will present that coach in the center and their biography.

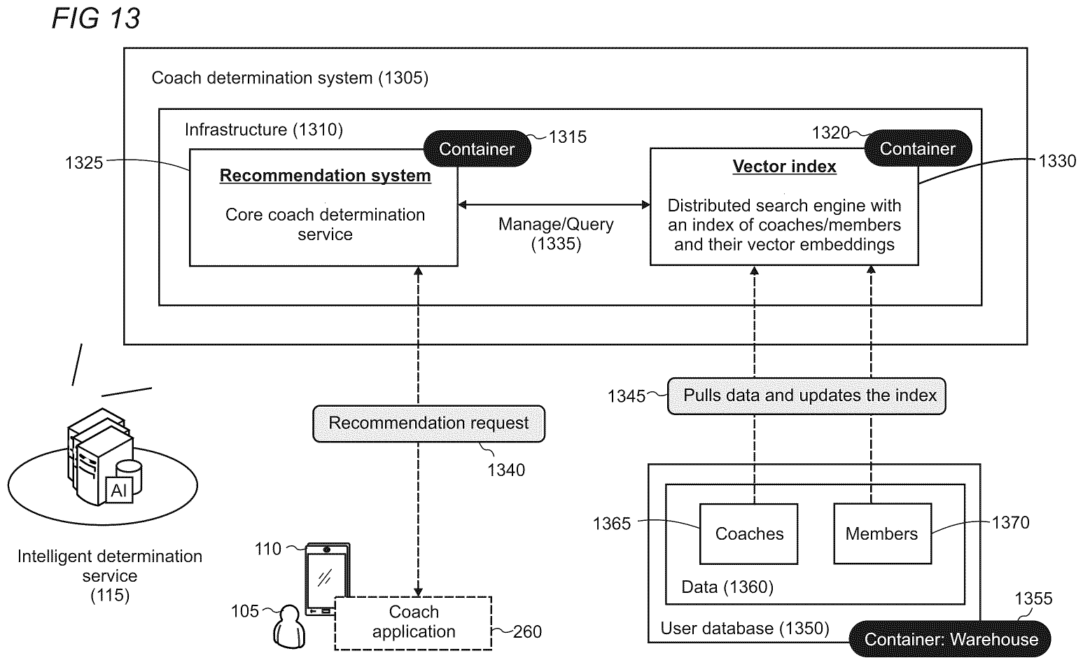

FIG. 13 shows an illustrative high-level system architecture of the intelligent determination system 115, which includes a coach determination system 1305 and a specific infrastructure 1310. The infrastructure components relate to the various system, stages, and components described above. The infrastructure includes a recommendation system 1325 and a vector index 1330. The recommendation system and vector index, while independent modules, interoperate with each other such that the recommendation system manages/queries 1335 the vector index to generate recommendations. The vector index pulls data and updates its index 1345 from a user database 1350, having data 1360 that includes at least information pertaining to coaches 1365 and members 1370. Such information can be derived as discussed above with respect to FIGS. 7 and 8.

The intelligent determination system 115 is set up using a containerized approach, such that the recommendation system 1325, vector index 1330, and user database 1350 are each independent containers 1315, 1320, and 1355, respectively. The user database container may be set up as a single database or separate containers for members and coaches. A user 105 operating the coach application 260 on their user device 110 may put in a recommendation request 1340, such as during an onboarding process 815 (FIG. 8), which sets in motion the coach determination system's functionality.

FIG. 14 shows an illustrative high-level system architecture of the intelligent determination system 115. Here, the coach application 260 operated by the user device 110 may communicate with the intelligent determination system's backend coach application system 1405. This backend coach application system interoperates with the distinct containers 1315, 1320, and 1350. As shown, this setup provides isolation and modularization among the various components, enabling independent services/software per module. Independent containers can be tailored based on their specific functionality, thereby enhancing and optimizing that specific system. This modularization/isolation enables the recommendation system 1325 to be set up with a different technical stack than the backend coach application system 1405 and/or the coach application 260. For example, the recommendation system can utilize, for example, Python and many Python-based packages, whereas the coach application 260 can be based on Ruby on Rails. The containerized structure also simplifies the deployment of such a service.

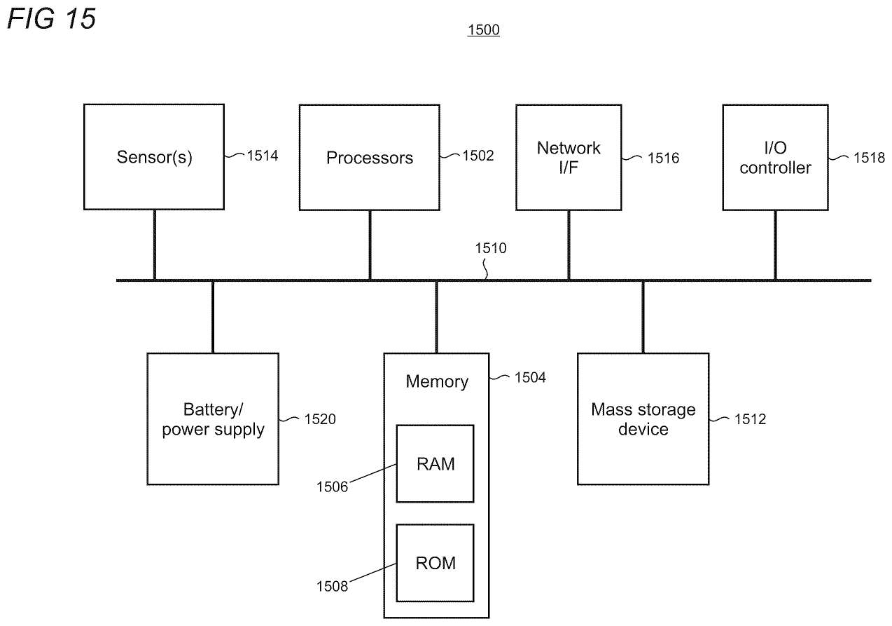

FIG. 15 shows an illustrative architecture 1500 for a computing device such as a user computing device (e.g., laptop computer, desktop computer, smartphone, etc.) for the present intelligent coach-member determination. The architecture 1500 may be non-exhaustive for a given computing device but may be utilized to execute the functions described herein.

The architecture 1500 illustrated in FIG. 15 includes one or more processors 1502 (e.g., central processing unit, dedicated Artificial Intelligence chip, graphics processing unit, etc.), a system memory 1504, including RAM (random access memory) 1506 and ROM (read-only memory) 1508, and a system bus 1510 that operatively and functionally couples the components in the architecture 1500. A basic input/output system containing the basic routines that help to transfer information between elements within the architecture 1500, such as during startup, is typically stored in the ROM 1508. The architecture 1500 further includes a mass storage device 1512 for storing software code or other computer-executed code that is utilized to implement applications, the file system, and the operating system. The mass storage device 1512 is connected to the processor 1502 through a mass storage controller (not shown) connected to the bus 1510. The mass storage device 1512 and its associated computer-readable storage media provide non-volatile storage for the architecture 1500. Although the description of computer-readable storage media contained herein refers to a mass storage device, such as a hard disk or CD-ROM drive, it may be appreciated by those skilled in the art that computer-readable storage media can be any available storage media that can be accessed by the architecture 1500.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVD, HD-DVD (High Definition DVD), Blu-ray, or other optical storage, a magnetic cassette, magnetic tape, magnetic disk storage or other magnetic storage device, or any other medium which can be used to store the desired information and which can be accessed by the architecture 1500.

According to various embodiments, the architecture 1500 may operate in a networked environment using logical connections to remote computers through a network. The architecture 1500 may connect to the network through a network interface unit 1516 connected to the bus 1510. It may be appreciated that the network interface unit 1516 also may be utilized to connect to other types of networks and remote computer systems. The architecture 1500 also may include an input/output controller 1518 for receiving and processing input from a number of other devices, including a keyboard, mouse, touchpad, touchscreen, control devices such as buttons and switches, or electronic stylus (not shown in FIG. 15). Similarly, the input/output controller 1518 may provide output to a display screen, user interface, a printer, or other output device types (also not shown in FIG. 15).

It may be appreciated that the software components described herein may, when loaded into the processor 1502 and executed, transform the processor 1502 and the overall architecture 1500 from a general-purpose computing system into a special-purpose computing system customized to facilitate the functionality presented herein. The processor 1502 may be constructed from any number of transistors or other discrete circuit elements, which may individually or collectively assume any number of states. More specifically, the processor 1502 may operate as a finite-state machine in response to executable instructions contained within the software modules disclosed herein. These computer-executable instructions may transform the processor 1502 by specifying how the processor 1502 transitions between states, thereby transforming the transistors or other discrete hardware elements constituting the processor 1502.

Encoding the software modules presented herein also may transform the physical structure of the computer-readable storage media presented herein. The specific transformation of physical structure may depend on various factors in different implementations of this description. Examples of such factors may include but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

The architecture 1500 may further include one or more sensors 1514 or a battery or power supply 1520. The sensors may be coupled to the architecture to pick up data about an environment or a component, including temperature, pressure, etc. Exemplary sensors can include a thermometer, accelerometer, smoke or gas sensor, pressure sensor (barometric or physical), light sensor, ultrasonic sensor, gyroscope, among others. The power supply may be adapted with an AC power cord or a battery, such as a rechargeable battery for portability.

In light of the above, it may be appreciated that many types of physical transformations take place in the architecture 1500 in order to store and execute the software components presented herein. It also may be appreciated that the architecture 1500 may include other types of computing devices, including wearable devices, handheld computers, embedded computer systems, smartphones, PDAs, and other types of computing devices known to those skilled in the art. It is also contemplated that the architecture 1500 may not include all of the components shown in FIG. 15, may include other components that are not explicitly shown in FIG. 15, or may utilize an architecture completely different from that shown in FIG. 15.

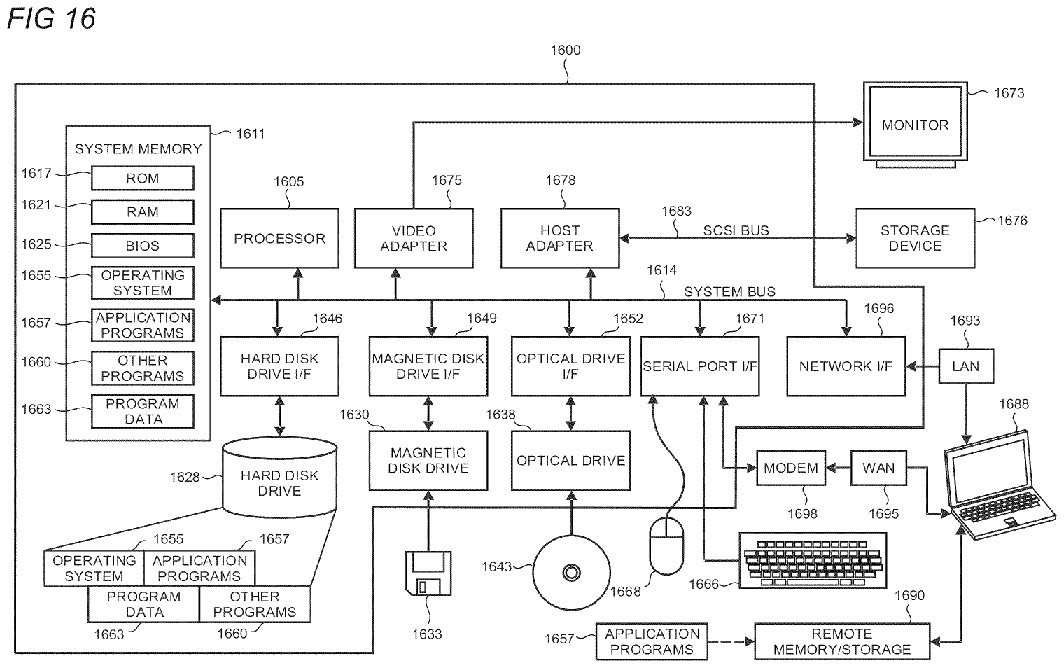

FIG. 16 is a simplified block diagram of an illustrative computer system 1600 such as a personal computer, control panel, server (such as remote service 150), or user computing device with which the present intelligent coach-member determination may be implemented.

Computer system 1600 includes a processor 1605, a system memory 1611, and a system bus 1614 that couples various system components including the system memory 1611 to the processor 1605. The system bus 1614 may be any of several types of bus structures, including a memory bus or memory controller, a peripheral bus, or a local bus using any of a variety of bus architectures. The system memory 1611 includes read-only memory (ROM) 1617 and random-access memory (RAM) 1621. A basic input/output system (BIOS) 1625, containing the basic routines that help to transfer information between elements within the computer system 1600, such as during startup, is stored in ROM 1617. The computer system 1600 may further include a hard disk drive 1628 for reading from and writing to an internally disposed hard disk (not shown), a magnetic disk drive 1630 for reading from, or writing to a removable magnetic disk 1633 (e.g., a floppy disk), and an optical disk drive 1638 for reading from or writing to a removable optical disk 1643 such as a CD (compact disc), DVD (digital versatile disc), or other optical media. The hard disk drive 1628, magnetic disk drive 1630, and optical disk drive 1638 are connected to the system bus 1614 by a hard disk drive interface 1646, a magnetic disk drive interface 1649, and an optical drive interface 1652, respectively. The drives and their associated computer-readable storage media provide non-volatile storage of computer-readable instructions, data structures, program modules, and other data for the computer system 1600. Although this illustrative example includes a hard disk, a removable magnetic disk 1633, and a removable optical disk 1643, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present intelligent coach-member determination. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof are intended to cover non-transitory embodiments and do not include waves, signals, and/or other transitory and/or intangible communication media.

A number of program modules may be stored on the hard disk, magnetic disk 1633, optical disk 1643, ROM 1617, or RAM 1621, including an operating system 1655, one or more application programs 1657, other program modules 1660, and program data 1663. A user may enter commands and information into the computer system 1600 through input devices such as a keyboard 1666 and pointing device 1668 such as a mouse. Other input devices (not shown) may include a microphone, joystick, gamepad, satellite dish, scanner, trackball, touchpad, touchscreen, touch-sensitive device, voice-command module or device, user motion or user gesture capture device, or the like. These and other input devices are often connected to the processor 1605 through a serial port interface 1671 that is coupled to the system bus 1614 but may be connected by other interfaces, such as a parallel port, game port, or universal serial bus (USB). A monitor 1673 or other type of display device is also connected to the system bus 1614 via an interface, such as a video adapter 1675. In addition to the monitor 1673, personal computers typically include other peripheral output devices (not shown), such as speakers and printers. The illustrative example shown in FIG. 16 also includes a host adapter 1678, a Small Computer System Interface (SCSI) bus 1683, and an external storage device 1676 connected to the SCSI bus 1683.

The computer system 1600 is operable in a networked environment using logical connections to one or more remote computers, such as a remote computer 1688. The remote computer 1688 may be selected as another personal computer, a server, a router, a network PC, a peer device, or other common network node, and typically includes many or all of the elements described above relative to the computer system 1600, although only a single representative remote memory/storage device 1690 is shown in FIG. 16. The logical connections depicted in FIG. 16 include a local area network (LAN) 1693 and a wide area network (WAN) 1695. Such networking environments are often deployed, for example, in offices, enterprise-wide computer networks, intranets, and the Internet.

When used in a LAN networking environment, the computer system 1600 is connected to the local area network 1693 through a network interface or adapter 1696. When used in a WAN networking environment, the computer system 1600 typically includes a broadband modem 1698, network gateway, or other means for establishing communications over the wide area network 1695, such as the Internet. The broadband modem 1698, which may be internal or external, is connected to the system bus 1614 via a serial port interface 1671. In a networked environment, program modules related to the computer system 1600, or portions thereof, may be stored in the remote memory storage device 1690. It is noted that the network connections shown in FIG. 16 are illustrative, and other means of establishing a communications link between the computers may be used depending on the specific requirements of an application of the present intelligent coach-member determination

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A remote determination system, comprising:
one or more processors;
one or more hardware-based memory devices storing computer-readable instructions which, when executed by the one or more processors causes the remote determination system to:
receive user information that describes at least one of user preferences and personality characteristics for multiple users;
establish a vector index that includes coach information and the received user information;
for a unique user, filter the established vector index to generate a set of candidates, in which filtering includes leveraging subsystems to identify an appropriate set of candidates for the unique user;
refine the generated set of candidates using a processing environment that identifies a subset of candidates; and
transmit the identified subset of candidates to the unique user.

2. The remote determination system of claim 1, wherein an artificial intelligence subsystem is utilized for filtering the established vector index.

3. The remote determination system of claim 1, wherein the subsystems include an NLP (natural language processing) subsystem or user-defined policies and criteria subsystem.

4. The remote determination system of claim 1, wherein the identified set of candidates for the unique user includes identifying candidate sets or a single set of top candidates.

5. The remote determination system of claim 1, wherein the processing environment for refining the generated set of candidates includes an AI (artificial intelligence) engine operating within an AI/ML (machine learning) environment to determine the subset of candidates.

6. The remote determination system of claim 5, wherein the processing environment further includes a hard-coded environment leveraging a point-based ordering system to determine the subset of candidates.

7. The remote determination system of claim 6, wherein the processing environment further includes the hard-coded environment leveraging a rule-based ordering system to determine the subset of candidates.

8. The remote determination system of claim 7, wherein the hard-coded and AI/ML environments interoperate with each other to identify the subset of candidates.

9. The remote determination system of claim 1, wherein the vector index and filtration steps operate in two distinct and independent containers within the remote determination system.

10. The remote determination system of claim 1, wherein the subsystems to identify an appropriate set of candidates for the unique user include a NLP (natural language processing) subsystem to parse the coach information and the user information to determine the set of candidates, a user-defined policies and criteria subsystem to apply criteria to the coach information and the user information to determine the set of candidates, and a machine learning/artificial intelligence subsystem to receive the coach information and the user information to determine the set of candidates.

11. The remote determination system of claim 10, wherein:
the NLP subsystem is used first,
the user-defined policies and criteria subsystem and the machine learning/artificial intelligence subsystem are used after the NLP subsystem.

12. The remote determination system of claim 1, wherein the set of candidates comprise top rated candidates based on the filtering.

13. The remote determination system of claim 1, wherein the subset of candidates comprise top candidates that satisfy a threshold.

14. A method performed by a remote determination system to filter and identify candidates using subsystems, comprising:
receiving user information that describes at least one of user preferences and personality characteristics for multiple users;
establishing a vector index that includes coach information and the received user information;
for a unique user, filtering the established vector index to generate a set of candidates, in which filtering includes leveraging subsystems to identify an appropriate set of candidates for the unique user;
refining the generated set of candidates using a processing environment that identifies a subset of candidates; and
transmitting the identified subset of candidates to the unique user.

15. The method of claim 14, wherein the subsystems to identify an appropriate set of candidates for the unique user include a NLP (natural language processing) subsystem to parse the coach information and the user information to determine the set of candidates, a user-defined policies and criteria subsystem to apply criteria to the coach information and the user information to determine the set of candidates, and a machine learning/artificial intelligence subsystem to receive the coach information and the user information to determine the set of candidates.

16. The method of claim 15, wherein:
the NLP subsystem is used first,
the user-defined policies and criteria subsystem and the machine learning/artificial intelligence subsystem are used after the NLP subsystem.

17. The method of claim 14, wherein the set of candidates comprise top rated candidates based on the filtering.

18. The method of claim 14, wherein the subset of candidates comprise top candidates that satisfy a threshold.

19. One or more hardware-based non-transitory computer-readable memory devices storing instructions which, when executed by one or more processors disposed within a remote determination system, cause the remote determination system to:
receive user information that describes at least one of user preferences and personality characteristics for multiple users;
establish a vector index that includes coach information and the received user information;
for a unique user, filter the established vector index to generate a set of candidates, in which filtering includes leveraging subsystems to identify an appropriate set of candidates for the unique user;
refine the generated set of candidates using a processing environment that identifies a subset of candidates; and
transmit the identified subset of candidates to the unique user.

20. The one or more hardware-based non-transitory computer-readable memory devices of claim 19, wherein the subsystems to identify an appropriate set of candidates for the unique user include a NLP (natural language processing) subsystem to parse the coach information and the user information to determine the set of candidates, a user-defined policies and criteria subsystem to apply criteria to the coach information and the user information to determine the set of candidates, and a machine learning/artificial intelligence subsystem to receive the coach information and the user information to determine the set of candidates.
